(19) United States
(12) Patent Application Publication
(10) Pub. No.: US 2022/0183492 A1
(43) Pub. Date: Jun. 16, 2022

(54) POWERED ARTIFICIAL TREES WITH RELEASABLY CONNECTED PRE-LIT BRANCH ASSEMBLIES AND ASSOCIATED METHODS

(71) Applicant: BELGRAVIA WOOD LTD, Central (HK)

(72) Inventors: Eric SZWEDA, Central (HK); Alan LEUNG, Central (HK)

(73) Assignee: BELGRAVIA WOOD LTD., Central (HK)

(21) Appl. No.: 17/644,080

(22) Filed: Dec. 13, 2021

Related U.S. Application Data
(60) Provisional application No. 63/125,104, filed on Dec. 14, 2020.

(51) Int. Cl. A47G 33/06; F21S 4/10

(52) U.S. Cl. CPC A47G 33/06; F21S 4/10

(57) ABSTRACT

Improved branch assemblies, artificial trees, and associated methods are disclosed. An example artificial tree includes a trunk, a plurality of electrical connectors, and a plurality of releasably connected pre-lit branch assemblies, the pre-lit branch assemblies comprising a plurality of lights, the plurality of branch assemblies operable to releasably mechanically connect to the trunk and releasably electrically connect to the plurality of electrical connectors. An example method of manufacturing an artificial tree includes installing a plurality of branch assemblies with a plurality of light strings to form a plurality of releasably connected pre-lit branch assemblies, releasably mechanically connecting the plurality of pre-lit branch assemblies to a trunk, and releasably electrically connecting the plurality of pre-lit branch assemblies to a plurality of electrical connectors.

### PRIORITY

This application claims priority to and the benefit under 35 U.S.C. § 119(e) of U.S. Provisional Patent Application No. 63/125,104, filed on Dec. 14, 2020, the contents of which are hereby incorporated by reference in their entirety.

### TECHNICAL FIELD

The present disclosure relates to powered artificial decorative trees, such as artificial Christmas trees.

This disclosure is motivated by two different, but equally significant, objectives. First, the methods and artificial trees of the present disclosure can increase the enjoyment and longevity of decorative trees, that are made and sold with pre-lit branches, and thereby reduce waste, by making it easier and cost effective for branches to be replaced when there is a problem with the lights. Importantly, the disclosed design ensures an environmentally friendly solution to lighting issues because replacement of single branches enables trees to be used longer and thereby not pre-maturely discarded. Second, this methods and artificial trees of the present disclosure can increase manufacturing flexibility, enabling producers to make the optimum use of skilled labor as part of a diversified supply chain, and also to reduce waste, such as reducing shipping costs, including reducing the amount of fuel that is used to ship trees to market. This disclosure further identifies manufacturing methods for making a tree with readily replaceable pre-lit branch assemblies.

### BACKGROUND

Decorative artificial trees are growing in popularity and in turn the types, styles and uses of these trees are multiplying. Usually made to resemble various types of fir or palm trees, or trees without foliage for Halloween, the artificial tree is still to this day largely a handicraft, produced in a liner manufacturing method. Artificial trees are often decorated and displayed indoors or outdoors to celebrate special occasions, or otherwise displayed to create ambiance. As decorative trees have evolved, more features and functionality have developed, but the resulting complexity of certain features has created problems for consumers and manufacturers that did not exist in earlier trees.

Earlier generation artificial trees consisted of a tree pole and individual branches that consumers had to attach one by one to the pole in order to set-up the tree. This method has certain advantages, such as enabling individual branches to be easily replaced if necessary. Further, shipping costs are generally reduced. These trees are also less expensive, so some of these type of trees are still made and sold. However, the design is more time consuming for the consumer when setting up and taking down the tree each season due to having to separately insert each branch and as such, these trees are declining in use.

The development of the hinged tree permits the branches to be installed on hinges at a factory. As will be appreciated, such a design allows the branches to be collapsed and the tree to be boxed, thus enabling the tree to be shipped, usually in two to three sections per tree. The consumer can set up the tree easily by folding open the hinged branches, akin to opening an umbrella, connecting the poles or trunks of each section, and setting into a tree stand.

Following soon thereafter, tree makers started to wrap the tree branches with light strings at the factory, thereby saving consumers from having to wrap the tree with their own stands of lights. The wrapped trees, also known as pre-strung or pre-lit, combined with the hinged branch design, served to make set up and take down of artificial trees an easier process for the consumer. A consumer may simply remove the sections of the trees from a box, put them together by connecting the poles, insert into a tree stand, and provide power.

But such designs increase difficulty and costs associated with providing maintenance for lighting problems that may arise . When a light string is defective, burns out, or lights are broken during use or storage, the replacement of the light string can be difficult and time consuming, and, for the consumer, ensuring that the replacement lights are uniform or consistent with the existing lights installed at a factory is difficult. Typically, a lighting problem will be limited to only a single light strand, branch, or section of the tree, but the current designs are such that the solution to the problem is often not limited to a quick and easy replacement of the problem lights. Often, typical maintenance requires replacement of the entire tree, or at best, a substantial section of the tree. If the light string is separately connected, it is difficult to extract the light string because the light string is wrapped and clipped into the branches and if even removable, ensuring that the new light string can be wrapped and clipped into place in a uniform or consistent manner as the other light string so the tree that were installed at the factory is difficult. The average consumer, having purchased a pre-strung tree, does not want to expend the time or effort to try to figure out how to un-string and then re-string a tree. Moreover, if the result will be a noticeable difference in the manner and method of that replaced string of lights, as compared to the rest of the tree, the effort will be rejected.

The problem of extracting a problematic light string is even greater when the tree maker has included power inside or along the tree pole and wired the light strings directly into the pole, or a pole connector connected to the tree pole. In these types of trees, the individual affected lights may be made to be part of a light string that does not have separate plugs, or any end connector at all, thus making their removal and replacement difficult for the average consumer. And again, even if the consumer could extract the affected lights, apart from a single bulb or two, replacing them in sections and ensuring uniformity or consistency with the rest of the tree is very difficult. Due to these facts, consumers often seek assistance of the retailer or the tree maker, but the only practical solution for the retailer or tree maker is to replace the entire tree, or at best, a large section of the tree, which will need to be shipped to the consumer, at great cost.

Another shortfall of existing artificial trees is in increased manufacturing costs. When manufacturing an artificial tree, lighting the tree requires a high degree of skill to ensure uniformity in the look and placement of lighting across the tree and to complete the lighting at a speed necessary to keep costs low. Since lighting is done for the whole tree or a large portion of the tree, trees are fully constructed where those workers with the lighting skills exist, so the lights can be strung last. As such, the final or near final step in the current manufacturing process—the stringing of trees—largely determines today where trees can be made in the world, as a practical matter. This causes the trees to be shipped as fully or near fully assembled, which is expensive.

### SUMMARY

Briefly described, the presently disclosed subject matter generally relates to improved decorative powered trees, and, more particularly, to artificial trees having releasably connected pre-lit branch assemblies and methods for manufacturing such trees.

For the consumer, as well as the retailer or tree maker providing after-sales support, the ideal replaceable pre-lit branch assembly provides a solution enabling both ready or easy removal and re-attachment of the branch including the wiring and lighting wrapped around or otherwise added to each branch. This necessitates an easy way of connecting, detaching and then re-connecting the wiring, or alternatively, easily re-establishing re-connection to lights via wireless connectivity, between the pole and the branch assemblies.

Likewise, for the tree maker, designs for enabling the pre-lit branch assemblies to be made and used as component parts results in flexibility that can dramatically change the manufacturing process. As previously stated, such a design could result in substantial savings in shipping costs, labor costs and other costs like duties or taxes, can be realized as substantial portions of manufacture of trees can take place closer to consumers.

Accordingly, aspects of the present disclosure relate to pre-lit branch assemblies being physically detachable from a tree pole and having wiring that is detachably connectable to the main power source of a tree (e.g., power running within or along a pole, radiating power source, etc.). For example, a pre-lit branch assembly, in accordance with the present disclosure, can include a main branch and a plurality of attached sub-branches, the main branch having a trunk connector assembly configured to allow for easy of attachment and detachment whilst ensuring a stable connection when attached. Further, the pre-lit branch assembly can include an electrical connector configured to allow for easy attachment and detachment whilst ensuring a stable connection when attached. In an example, a pre-lit branch assembly can include a single light string disposed on the branch and the single light string can include a connector configured to mate with a connector that can be used by the consumer to readily detach and re-attach the light string. In another example, a pre-lit branch assembly can include multiple branches having one or more light strings disposed across the branches and at least one of the light strings can include a connector configured to mate with a connector that can be used by the consumer to readily detach and in turn re-attach the light string.

In yet another example, the trunk can include a wireless or radiating power source and the pre-lit branch assembly can include a light string having an end connector configured to wirelessly receive power from the trunk power source and distribute the power throughout the light string. Further, instead of a light string, in an example, the pre-lit branch assembly can include a plurality of individual light emitters that are each configured to wirelessly receive power from the trunk. As will be appreciated, such embodiments reduce the need for at least portions of the wiring which can reduce the unit costs associated with trees. As will be further appreciated, the incorporation of the wireless power decreases the need for physical connecting and disconnecting of lighting during both manufacturing and maintenance of trees.

Further, examples of the present disclosure provide improved methods of manufacturing pre-lit artificial trees comprising a plurality of releasably connected pre-lit branch assemblies.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate several embodiments and, together with the description, serve to explain the disclosed principles. The drawings are not intended to limit the scope of the presently disclosed subject matter in any manner. In the drawings:

FIG. 1 depicts a schematic diagram of an assembled artificial tree with releasably connected pre-lit branch assemblies, in accordance with some examples of the present disclosure.

FIG. 2 depicts a captured image of an releasably connected pre-lit branch assembly electrically connected to an artificial tree, in accordance with some examples of the present disclosure.

FIGS. 3A and 3B depict captured images of example connectors for use in electrically connecting an releasably connected pre-lit branch assembly to a section of an artificial tree, in accordance with some examples of the present disclosure.

FIG. 4 depicts a captured image of releasably connected pre-lit branch assembly electrically connected to an artificial tree, in accordance with some examples of the present disclosure.

FIG. 5 depicts a captured image of a releasably connected pre-lit branch assembly electrically connected to an artificial tree, in accordance with some examples of the present disclosure.

FIG. 6 depicts a flow chart of the process of electrically connecting an releasably connected pre-lit branch assembly to a section of an artificial tree, in accordance with some examples of the present disclosure.

FIG. 7 depicts a captured image of a section of an artificial tree having a plurality of releasably connected pre-lit branch assemblies electrically and mechanically connected thereto, in accordance with some examples of the present disclosure.

FIG. 8 depicts a captured image of a distribution hub of an artificial tree that includes a plurality of releasably connected pre-lit branch assemblies electrically and mechanically connected thereto, in accordance with some examples of the present disclosure.

FIG. 9 depicts a captured image of a distribution hub electrical and mechanically connected to a section of an artificial tree, in accordance with some examples of the present disclosure.

FIG. 10 depicts a capture image of a mechanical connector for securing a distribution hub to a section of an artificial tree, in accordance with some examples of the present disclosure.

FIGS. 11A and 11B depict a schematic diagram of an assembled artificial tree with releasably connected pre-lit branch assemblies, in accordance with some examples of the present disclosure.

FIG. 12 depicts an schematic diagram of a releasably connected pre-lit branch assembly having a plurality of brancheselectrically connected to one another via a wiring harness, in accordance with some examples of the present disclosure.

FIG. 13 depicts a schematic diagram of the mechanical connection of an releasably connected pre-lit branch assembly on a section of an artificial tree, in accordance with some examples of the present disclosure.

FIGS. 14A and 14B depict a schematic diagram of a removable fastener and end caps, in accordance with some examples of the present disclosure.

FIG. 15 depicts a flow chart of a method of manufacturing an artificial tree in accordance with some examples of the present disclosure.

FIG. 16 depicts a schematic diagram of an artificial tree with releasably connected pre-lit branch assemblies and wireless transmission capabilities, in accordance with some examples of the present disclosure.

FIG. 17 depicts a schematic diagram of a cotter pin and clevis pin in accordance with some examples of the present disclosure.

FIGS. 18A and 18B depict a schematic diagram of an assembled artificial tree with releasably connected pre-lit branch assemblies, in accordance with some examples of the present disclosure.

FIGS. 19A and 19B depict a schematic diagram of an assembled artificial tree with releasably connected pre-lit branch assemblies, in accordance with some examples of the present disclosure.

FIGS. 20A and 20B depict a schematic diagram of an assembled artificial tree with releasably connected pre-lit branch assemblies, in accordance with some examples of the present disclosure.

FIG. 21 depicts a schematic diagram of a harness of an assembled artificial tree with releasably connected pre-lit branch assemblies, in accordance with some examples of the present disclosure.

### DETAILED DESCRIPTION

Examples of the present disclosure relate to decorative artificial trees, such as Christmas trees, palm trees, Halloween trees and the like. Although preferred examples of the disclosed technology are explained in detail, it is to be understood that other examples are contemplated. Accordingly, it is not intended that the disclosed technology is limited in its scope to the details of construction and arrangement of components set forth in the following description or illustrated in the drawings. The disclosed technology is capable of other examples and of being practiced or carried out in various ways. Also, in describing the preferred examples, specific terminology will be resorted to for the sake of clarity. It is intended that each term contemplates its broadest meaning as understood by those skilled in the art and includes all technical equivalents which operate in a similar manner to accomplish a similar purpose.

To facilitate an understanding of the principles and features of the disclosed technology, various illustrative examples are explained below. In particular, the presently disclosed technology is described in the context of being an improved artificial tree with releasably connected pre-lit branch assemblies in addition to improved methods of manufacturing such tress and their associated component assemblies. Some examples of the disclosed technology are disclosed in the context of being mechanical and/or electrical component assemblies for use in a powered artificial tree. The present disclosure, however, is not so limited, and can be applicable in other contexts. For example, and not as a limitation, the present disclosure may improve other power systems, such as light poles, lamps, extension cord systems, power cord connection systems, patio umbrellas, and the like. These examples are contemplated within the scope of the present disclosure. Accordingly, when the present disclosure is described in the context of mechanical and/or electrical components for an artificial tree, it will be understood that other examples can take the place of those referred to.

The present disclosure describes artificial trees and methods of manufacturing the artificial trees that overcome problems of other trees and methods. First, the artificial trees disclosed herein provide for easier and less expensive fixes when there is an issue with a part of the tree. For example, light bulbs and/or light string sometimes become defective, burn out, or are otherwise damaged during use or storage. Typically, such problem will be limited to a problem locale, such as a single light strand, branch, or section of the tree, however, due to the integrated nature of current tree designs focused on easing assembly/disassembly, solving maintenance problems is often not possible at problem locale. In other artificial trees, typical maintenance to repair lighting issues requires replacement of the entire tree, or at best, a substantial section of the tree.

The present disclosure greatly reduces the cost and effort needed to repair these issues by allowing, for example, a single branch to be replaced when a light bulb becomes defective (instead of an entire tree or section thereof). More specifically, the present disclosure describes artificial trees having releasably connected pre-lit branch assemblies and improved methods of manufacturing releasably connected components for such trees to encourage manufacturing flexibility.

Aspects of the present disclosure relate to pre-lit branch assemblies being releasably connected to a tree pole and having wiring that is releasably connected to the main power source of a tree (e.g., power running within or along a pole, radiating power source, etc.). For example, a releasably connected pre-lit branch assembly, in accordance with the present disclosure, can include a main branch and a plurality of attached sub-branches, the main branch having a trunk connector assembly configured to allow for easy of attachment and detachment whilst ensuring a stable connection when attached. Further, the pre-lit branch assembly can include an electrical connector configured to allow for easy of attachment and detachment whilst ensuring a stable connection when attached.

Additionally, the present disclosure overcomes inefficiencies and alleviates costs of prior manufacturing methods. Current methods of making pre-lit trees involves adding the lighting to integrated portions of a tree as one of the final steps in the manufacturing process. This final step requires the most skill on the part of the people crafting the tree and as such, often requires years of training and experience, to apply the lights uniformly across the branches and the tree. The integrated nature in which these trees are made, specifically in which branches are strung, makes it impossible for untrained consumers to replicate the uniformity required to maintain the aesthetic quality of the tree. Hence, one of the reasons as to why the most often fix by retailers or manufacturers is to send either an entire replacement tree or at least an entire section.

One solution provided by some aspects of the present disclosure is to provide a manufacturing method that permits the stringing of the tree can be performed apart from the final production of the tree. More specifically, if the making and stringing or lighting of branches can be separated from the rest of the tree manufacturing process, this method will enable the lighted branches to be made by the skilled artisans, while the rest of the tree can be made elsewhere. In particular, if the final manufacturing of the tree can be undertaken in or near the final market destination, shipping costs and fuel usage will be decreased, and other savings can result, such as access to lower wage rates or lower duties or taxes in other locations around the world. Further, aspects of the present disclosure relate to improved methods of manufacturing artificial trees comprising providing an powered trunk, providing a plurality of releasably connected pre-lit branch assemblies, mechanically connecting the plurality of releasably connected pre-lit branch assemblies to the powered trunk, and electrically connecting the plurality of releasably connected pre-lit branch assemblies to the powered trunk. As will be appreciated such methods provide substantial savings in fuel and other shipping costs by reducing the geographic restrictions thus enabling producers to make the optimum use of skilled labor as part of a diversified supply chain. For example, utilizing such a distributed manufacturing process allows skilled workers in one location can contribute the component or parts of the tree necessitating their skill, while lesser skilled laborers in other locations can contribute to the production of other parts or components and in turn substantially manufacture of the full and final product in locations closer to consumers.

It thus may now be appreciated the methods and artificial trees disclosed herein significantly change the manufacturing process by taking the final step in the now linear process and making it an earlier and separate step in the process. This change in manufacturing methods requires that the lighted branch be made a separate component, which then also enables the ultimate consumer, to readily remove and replace what now will be an releasably connected pre-lit branch assembly. It is not merely that the light string is readily removed and replaced, but the entire branch can be readily removed and replaced. One or the other is not sufficient. It is the combination of these two elements of tree design that work together to solve the noted problems of manufacturing and light replacement.

Referring now to the figures, wherein like reference numerals represent like parts throughout the views, examples of the present disclosure will be described in detail.

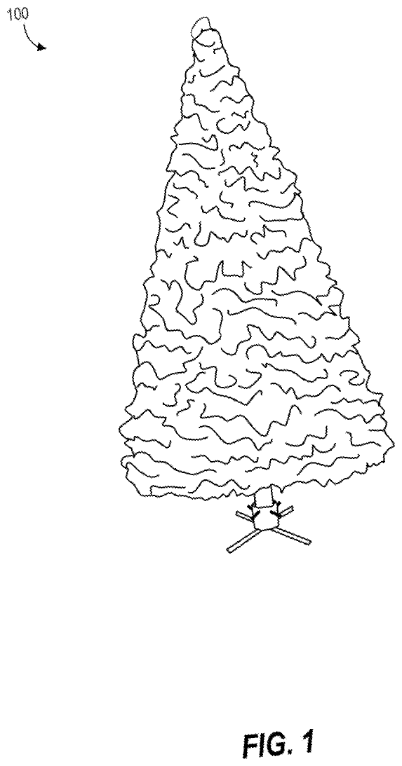

FIG. 1 depicts an assembled artificial tree 100 with releasably connected component assemblies, such as releasably connected pre-lit branch assemblies described in more detail further herein. The tree 100 can include a plurality of tree sections which can be releasably connected to form the tree 100. In some embodiments, the mechanical connection is separate and independent from the electrical connection and they can be connected at different times. In alternative embodiments, the electrical and mechanical connections are dependent upon each other. In alternative embodiments, the connection is an electromechanical connection that provides both a mechanical and electrical connection. In some embodiments, the electrical connection occurs wirelessly. Each trunk section of the artificial tree can be a powered trunk section having an internal power distribution system including a plurality of conductors and an electrical connector for electrically and mechanically connecting to other trunk sections. Each trunk section can further include one or more component assemblies configured to be releasably connected to the trunk section.

As will be appreciated, such an improved releasably connected design provides for ease of maintaining the tree 100 if problems arise thus overcoming the previously discussed problems associated with maintaining currently available artificial trees. As will be further appreciated, the benefits of artificial trees having releasably connected designs are not limited to situations where problems exist. For the consumer, the interchangeability allows for modifications and/or upgrades to their tree as technology continues to improve. For example, new lighting technologies that allow for increased lighting effects may be integrated added to trees in the form of releasably connected pre-lit branch assemblies, such as those discussed further herein. By way of another example, consumers may seek to set up a single tree to enjoy across seasons or holidays, and do so by replacing only the branches with styles dedicated to a particular occasion. Additionally, for the manufacturers of artificial trees, the releasably connected design and nature of the present methods and artificial trees of the present disclosure increase manufacturing flexibility, thus enabling producers to make the optimum use of resources, such as the previously discussed skilled laborer's, as part of a diversified supply chain. The enabled optimum manufacturing processes will lead to reduce waste, such as reducing shipping costs, including reducing the amount of fuel that is used to ship trees to market.

As an example, a trunk section can include a plurality of releasably connected pre-lit branch assemblies configured to be mechanically attachable and detachable to a trunk body of the trunk section and electrically attachable and detachable to the main power source of a tree (e.g., power running within a pole, radiating power source, non-radiating wireless energy field, etc.).

As a further example, a trunk section can include one or more releasably connected wiring harnesses configured to electrically connect the lighting elements of a releasably connected pre-lit branch assembly to the main power within or along a trunk section. As will be appreciated, such wiring harnesses allow for ease of connection and disconnection while also providing flexibility for the overall tree assembly. For example, wiring harnesses can be designed to allow for various types of power (e.g., low voltage systems for powering LEDs or small electronics, medium voltage systems for providing power for a large array of LEDs or small electronics, high voltage systems originating from a wall outlet, etc.) and lighting configuration (e.g., series wired lighting elements, parallel wired lighting elements, series wired light strings, parallel wired light strings, parallel series wired light strings, series parallel wired light strings, etc.). Such design flexibility benefits both the consumers as they have the ability to easily maintain and customize their tree, but also to the manufacturers as their ability to manufacture a batch of releasably connected components can lead to vast array of easily assembled trees. Additionally, electrical connection can carry power, data, or both. For example, an electrical connection can facilitate the powering lights on a pre-lit branch assembly. An electrical connection can facilitate the transmission of a control signal operable to, for example, change lighting settings of pre-lit branch assemblies.

The disclosure is not limited to electrical connections dependent on mechanical connection. For example, wireless transmission of energy can be used to provide power for the lights on the branches without having to use physical couplers between wiring in or along the pole or tree trunk and the branches. This can be accomplished by near field or non-radiative wireless transmission which enables power to be transferred over short distances by magnetic fields using inductive coupling between coils of wire, or by electric fields using capacitive coupling between metal electrodes.

In such an example, a power transmission unit can be connected to the pole or base or separately situated in or around the tree and can utilize the electricity from an external source to generate a beam of electromagnetic radiation. This beam can take the form of visible light, microwave radiation, near infrared radiation or any appropriate frequency or frequencies, depending on the technology chosen. The interchangeable component assemblies can include a power reception unit receives power from one or several power transmitters, and converts the total power received to electricity. Similar to the focusing of the transmitted power, it is possible to concentrate the received power for conversion, using receiving arrays, antennas, reflectors or similar means. The power reception unit technology can be a rectenna, a photovoltaic cell, nanotechnology antennas or any other technology capable of converting electromagnetic radiation to electricity, or any combination of the above.

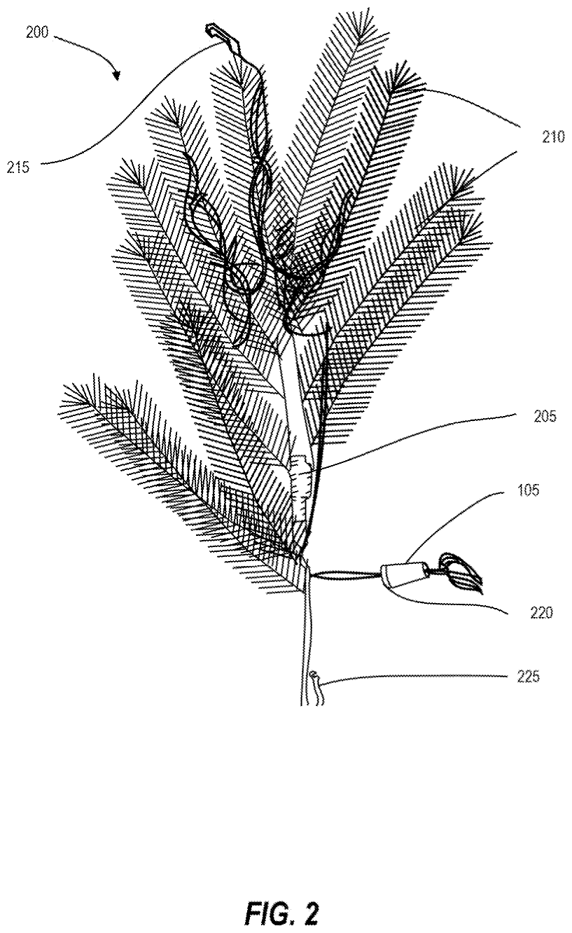

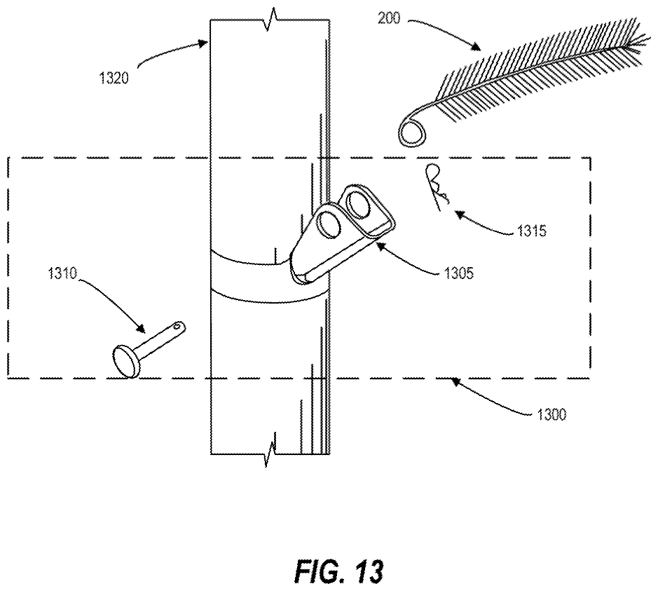

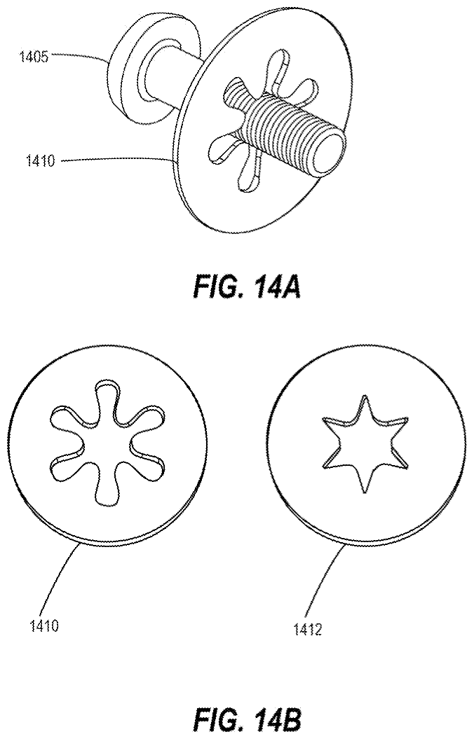

FIG. 2 depicts a releasably connected pre-lit branch assembly 200 electrically connected to an artificial tree 100. As depicted, releasably connected pre-lit branch assembly 200 can include a main branch 205 and a plurality of attached sub-branches 210. As further depicted, the main branch 205 can include a trunk connector assembly 225, described in more detail below with respect to FIGS. 13, 14A, and 14B. Trunk connector assembly 225 can configured to allow for easy of attachment and detachment to the artificial tree 100 whilst ensure a stable connection when attached. The trunk connector assembly 225, as depicted, is in an unassembled state.

The pre-lit branch assembly 200 as well as other releasably connected components discussed here may be releasably connected in several ways. In some embodiments, the mechanical connection is separate and independent from the electrical connection and the mechanical connection and the electrical connection can be connected separately. For example, the mechanical connection can include that shown in FIG. 13, while the electrical connection includes a plug and receptacle pair or wirelessly connection (or both). In alternative embodiments, the electrical and mechanical connections are dependent upon each other. That is, a connector has both an electrical connector and a mechanical connector (e.g., mechanical pins and receptacles and electrical plugs and receptacles). In other embodiments, the connection is an electromechanical connection that provides both a mechanical and electrical connection. For example, plug and receptacle pairs may establish electrical and mechanical connection such that the pre lit branch assembly is releasably attached to another component such as a trunk and receives electrical signal from the component. In some embodiments, the electrical connection occurs wirelessly. The wireless electrical connection may be of data or power or both. There may be multiple electrical and/or mechanical connections. For example, a pre-lit branch assembly may receive power from a wired connection and data from a wireless connection. The wireless electrical connection may occur as a result of the mechanical connection (e.g., the mechanical connection brings the branch assembly in range of a wireless signal to thereby establish a wireless connection).

Additionally, electrical connection may be established indirectly. For example, the branch assemblies may be electrically connected to a trunk, while the branch assemblies are indirectly electrically connected to the trunk (e.g., the branch assemblies are electrically connected to a harness which is electrically connected to the trunk thereby establishing an indirect electrical connection between the branch assemblies and the trunk).

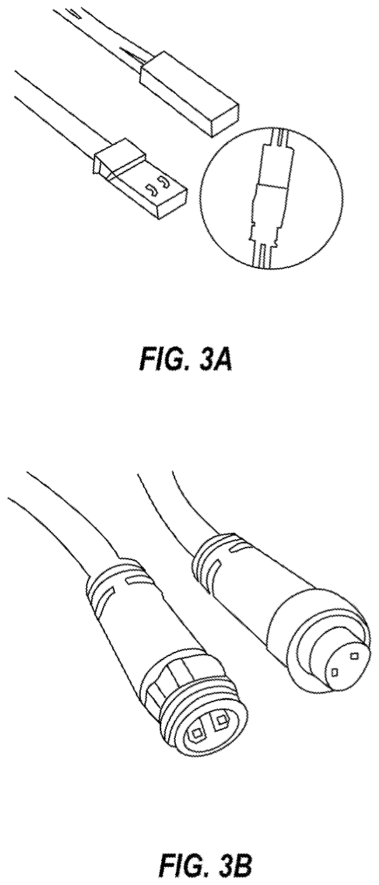

Also, as shown, the pre-lit branch assembly 200 can include a light string 215 and an electrical connector 220 configured to allow for easy of attachment and detachment to an electrical connector 105 of the artificial tree 100 whilst ensure a stable connection when attached. The electrical connectors 220, 105 are depicted as a plug and receptacle pair, sometimes referred to as a lamp lock assembly. As will be appreciated, many connector types can be used for electrically connecting an releasably connected pre-lit branch assembly to a section of an artificial tree, such as, the example connectors depicted in FIGS. 3A, and 3B. The electrical connectors described herein may carry, power, data, or both. FIG. 3A depicts an electrical connector, a plug and receptacle pair, known as a two-pin connector assembly. FIG. 3B depicts an electrical connector, a two-pin connector assembly having a different geometric footprint than the two-pin connector assembly from FIG. 3A. FIG. 3B depicts an electrical connector, a plug and receptacle pair, known as a DC or barrel connector assembly. As will be appreciated the type of electrical connector can be varied so long as it is able to be connected and disconnected such that the pre-lit branch assembly 200 can be releasably connected. Electrical connectors may alternatively or additionally be a pin, a hole, a plug, a pair, wireless transmitters, wireless receivers, wireless receives, portions thereof, or a combination thereof. An “electrical connector” may be one or more of the aforementioned electrical connectors (i.e., an electrical connector may be a plug or a plug and receptacle pair).

In an example, a pre-lit branch assembly 200 can include a single light string 215 disposed on the branches 205, 210 and the single light string 215 can include an electrical connector 220 configured to mate with a connector 105 built into the trunk. In another example, a pre-lit branch assembly 200 can include multiple branches having one or more light strings 215 disposed across the branches and at least one of the light strings 215 can include a electrical connector configured to mate with a electrical connector 105 built into the trunk.

In yet another example, the artificial tree 100 can include a wireless or radiating power source with an electrical connector configured to transmit power to the pre-lit branch assembly 200 having a light string 215 with an electrical connector 220 configured to wirelessly receive power from the trunk power source and distribute the power throughout the light string. Further, instead of a light string 215, in an example, the pre-branch assembly 200 can include a plurality of individual light emitters that are each configured to wirelessly receive power from a wireless power source in the artificial tree 100. As will be appreciated, such embodiments reduce the need for at least portions of the wiring which can reduce the unit costs associated with trees. As will be further appreciated, the incorporation of the wireless power decreases the need for physical connecting and disconnecting of lighting during both manufacturing and maintenance of trees.

FIGS. 3A and 3B depict example electrical connectors for use in electrically connecting a releasably connected pre-lit branch assembly to a section of an artificial tree, in accordance with some examples of the present disclosure.

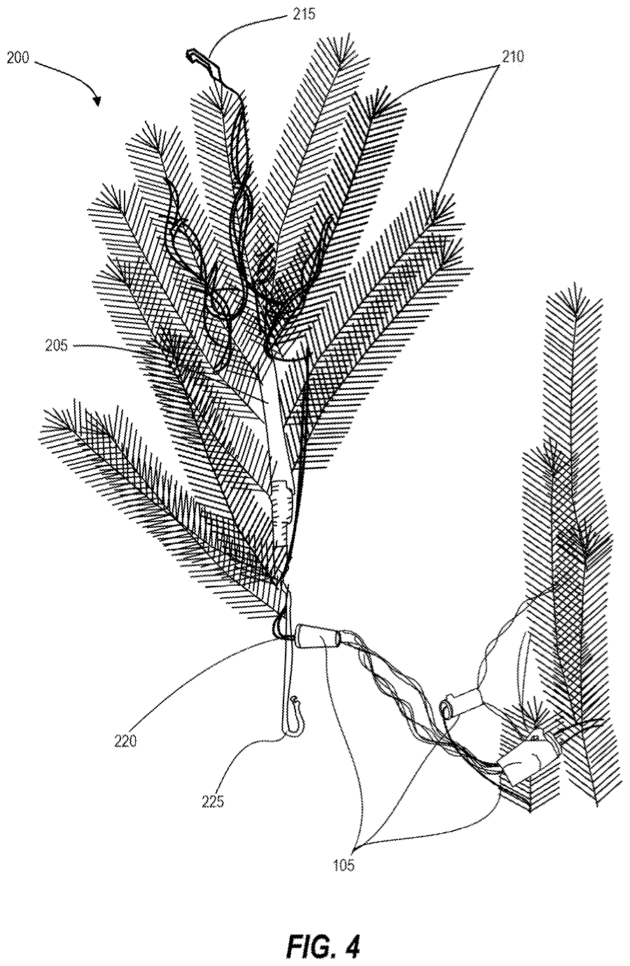

FIG. 4 depicts an alternate view of releasably connected pre-lit branch assembly 200 electrically connected to an artificial tree. As depicted in FIG. 4, in some examples, artificial tree 100 can include a plurality of electrical connectors 105 configured to connect with respective releasably connected pre-lit branch assemblies 200.

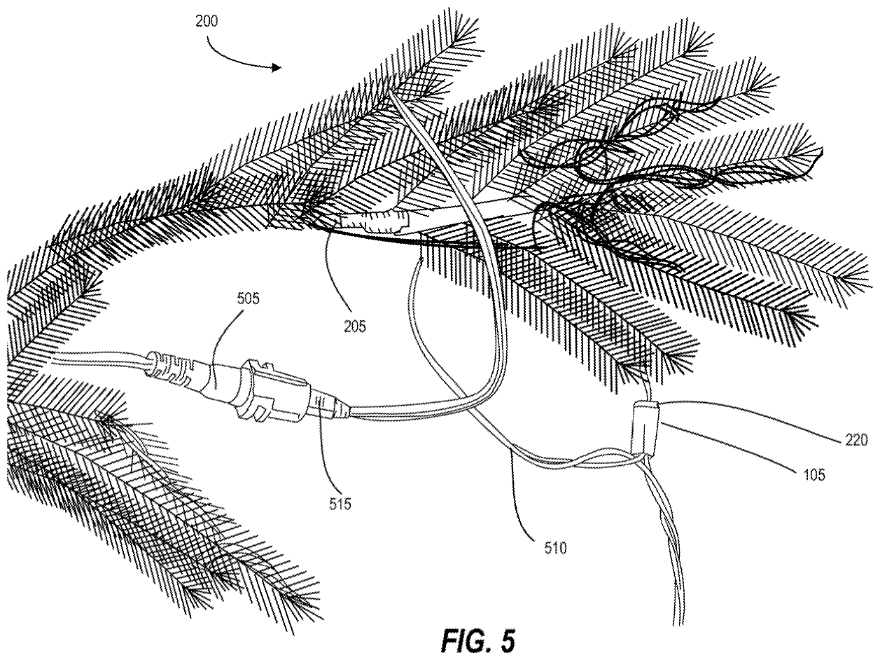

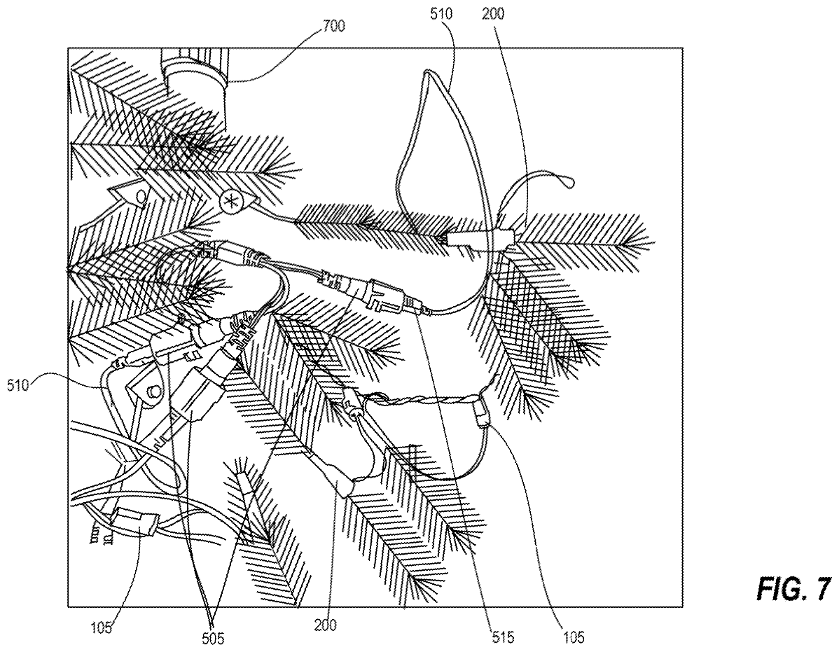

FIG. 5 depicts a releasably connected pre-lit branch assembly 200 in an electrically connected state, such that the end connector 220 is connected to the connector 105 of the wiring harness of the artificial tree 100. As depicted, the artificial trunk can include pre-lit branch assembly 200 that can include a distribution hub, further described below with respect to FIGS. 7-10. The distribution hub can include a wiring harness connector 505 that is configured to mate with an releasably connected wiring harness 510.

As depicted, releasably connected wiring harness 510 can include a plurality of electrical connectors. The plurality of electrical connectors includes distribution connector 515 and one or more light string connectors 105. The plurality of electrical connectors could include additional or less electrical connectors, such as distribution connectors, light string connectors, power trunk connectors, or any other suitable connector(s). The distribution connector 515 can be configured to mate with an electrical connector, e.g., a wiring harness connector 505, of a distribution hub in order to receive power and/or data signals from the trunk section. For example, the distribution hub can send a control signal to adjust the brightness, color, flicker, or flash of lights. As another example, the distribution hub can send a power signal to illuminate the lights. The one or more light string connectors 105 of the releasably connected wiring harness 510 can be configured to mate with one or more light string connectors 220 of respective releasably connected pre-lit branch assemblies 200 in order to transmit the power and/or data signals from the trunk section to the light strings 215. As will be appreciated, a distribution hub could be configured to mate directly with the one or more light string connectors 220 of respective releasably connected pre-lit branch assemblies 200. As will be appreciated, a variety of electrical connectors can be used for the various light string, wiring harness, and power/data distribution connectors described herein for connecting the light string 215 on the branch assemblies 200 to the pole wiring.

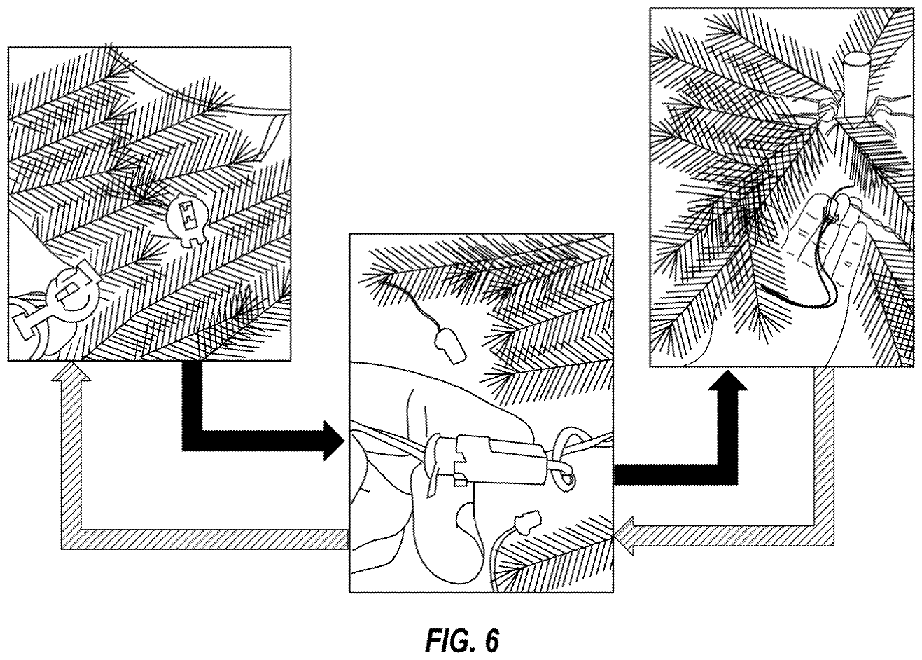

FIG. 6 depicts the process of electrically connecting and disconnecting an releasably connected pre-lit branch assembly 200 to a section of an artificial tree, in accordance with some examples of the present disclosure. As shown, in order to electrically connect an releasably connected pre-lit branch assembly 200, either as part of an assembly or maintenance operation, the light string connector 220 of the pre-lit branch assembly 200 may be connected with the light string connectors 105 of the trunk portion. As shown, light string connector 220 can include a first locking mechanism configured to mate with a second locking mechanism of light string connector 105.

FIG. 7 depicts a section of an artificial tree 700 having a plurality of releasably connected pre-lit branch assemblies 200 electrically and mechanically connected thereto. As shown, tree section 700 includes a distribution hub that includes a plurality of electrical connectors, that is, a plurality of wiring harness connectors 505 that are configured to mate with a plurality of releasably connected wiring harnesses 510. In some examples, a plurality of wiring harness connectors 505 can be configured to connect directly with light string connector 220 of the pre-lit branch assembly 200 instead of going through an intermediary wiring harness. As further depicted, the plurality of releasably connected wiring harnesses 510 can include other electrical connectors. For example, the releasably connected wiring harness 510 can include a plurality of light string connectors 105 configured to electrically connect with respective light string connectors 220 of the plurality of pre-lit branch assemblies 200. When fully assembled, each pre-lit branch assemblies 200 can receive power and/or data signals from the trunk through the distribution hub and through a respective releasably connected wiring harness 510.

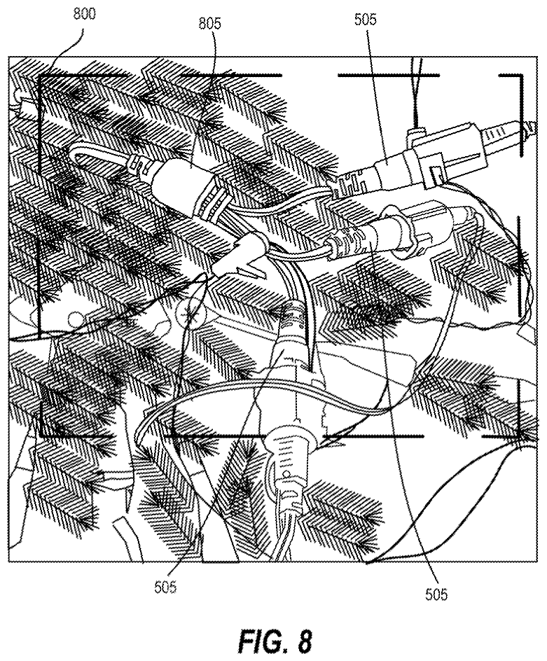

FIG. 8 depicts a distribution hub 800 of an artificial tree that includes a plurality of releasably connected pre-lit branch assemblies 200 electrically and mechanically connected thereto, in accordance with some examples of the present disclosure. As shown, distribution hub 800 can include an electrical connector, a hub connector 805, configured to receive an input power from the trunk interior and split the power. Distribution hub 800 can further include a plurality of wiring harness connectors 505 configured to receive and transmit the split input power to either a plurality of releasably connected wiring harnesses 510 or directly to a plurality of light string connectors 220 of the plurality of pre-lit branch assemblies 200. As will be appreciated, in some examples a plurality of wiring harness connectors 505 can include some connectors configured to mate with a plurality of releasably connected wiring harnesses 510 while other connectors that are configured to mate directly to a plurality of light string connectors 220 of the plurality of pre-lit branch assemblies 200.

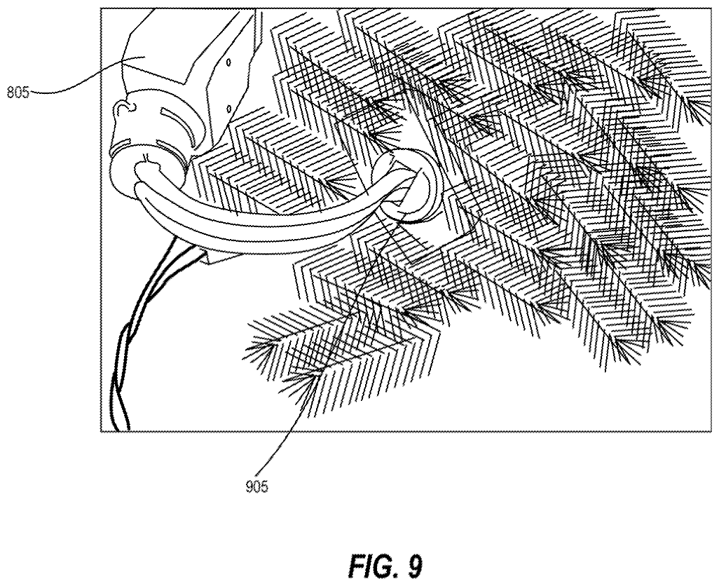

FIG. 9 depicts a distribution hub 800 electrical and mechanically connected to a section of an artificial tree, in accordance with some examples of the present disclosure. The distribution hub 800 can distribute data, power, or both, to lights or another component of an artificial tree. For example, the distribution hub can send a control signal to adjust the brightness, color, flicker, or flash of lights. As another example, the distribution can send a power signal to illuminate the lights. As shown, distribution hub 800 can include a trunk securing nut 905 configured secure the input power line of the distribution hub 800 to a portion of trunk section's trunk wall. As will be appreciated, the connection and disconnection of the various connectors described herein will put strain on the distribution hub 800, which if left unchecked would put strain on the internal components of the artificial trunk. If the internal components of a trunk section get damaged due to such strain, the benefits gained from the interchangeability of the component assemblies is defeated as a consumer will not have the ability to get inside the trunk portion. To prevent such damage, a trunk securing nut 905 is included to provide strain relief.

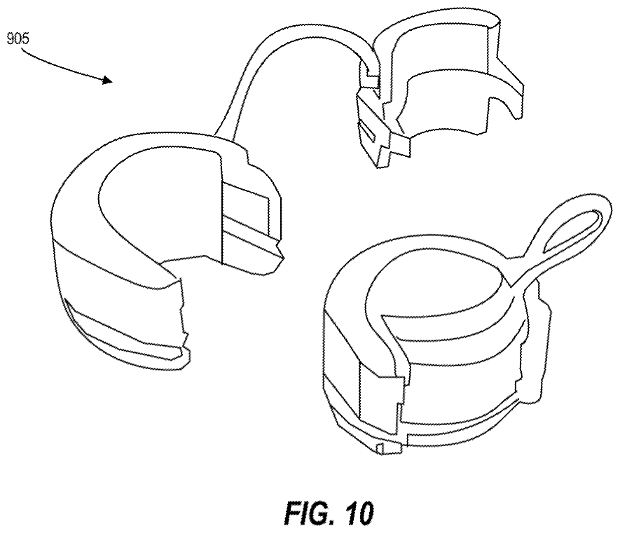

FIG. 10 depicts a mechanical connector, such as a trunk securing nut 905, for securing a distribution hub 800 to a section of an artificial tree, in accordance with some examples of the present disclosure. As shown, trunk securing nut 905 can include a ridged portion configured to receive a perimeter of a cut-out portion of the trunk wall. As further depicted, trunk securing nut 905 can include a clamping portion configured to clamp an input power line of the distribution hub 800 such that the strain on the distribution hub 800 is transferred from the clamped portion of the input power line to the trunk wall.

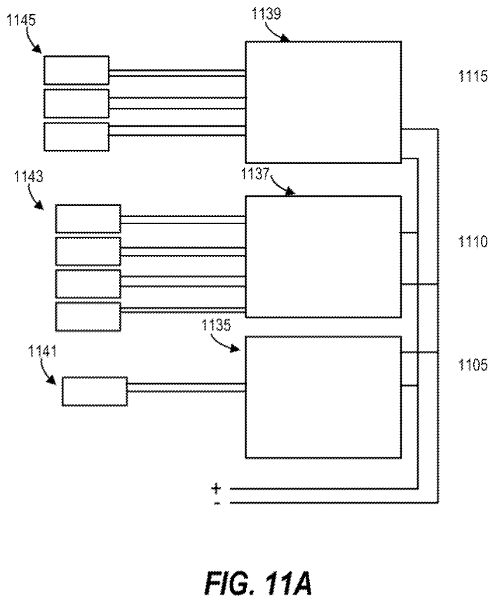

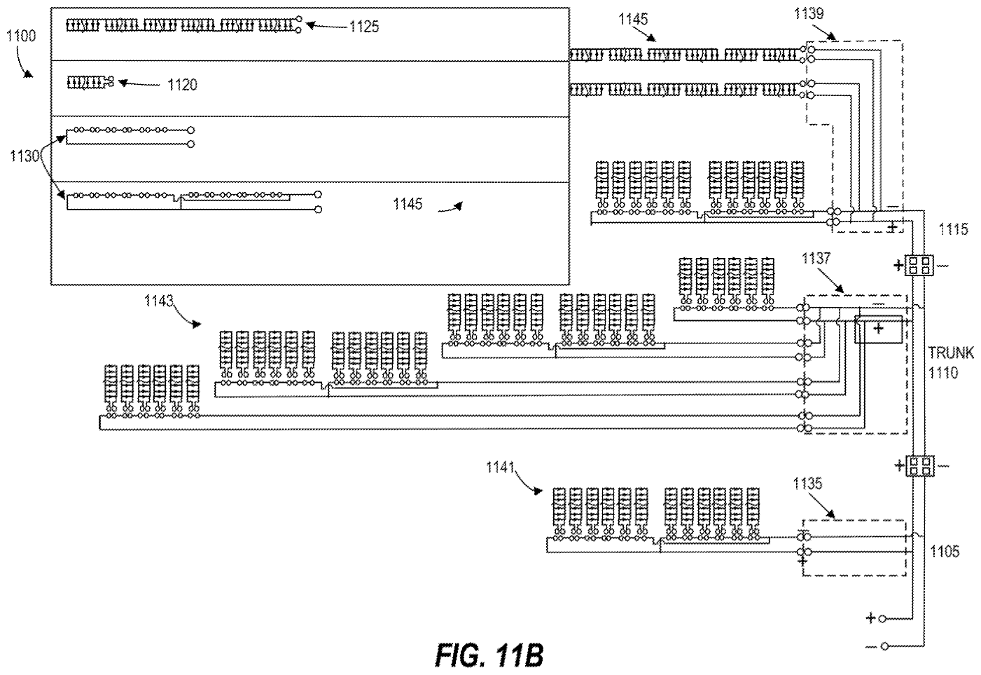

FIGS. 11A and 11B depict an electrical wiring diagram of an assembled artificial tree 1100 with releasably connected pre-lit branch assemblies, in accordance with some examples of the present disclosure. The artificial tree 1100 has a tiered electrical configuration facilitating releasably connecting in an artificial tree by maintaining acceptable voltage levels for lights (e.g., 3V), while simultaneously distributing lights among connection points as would be physically practical and aesthetically pleasing. That is, the depicted tiered electrical configuration of the artificial tree 1100 has an appropriate number of lights at the top of a tree (which is smaller) and a larger amount of lights at a base of a tree (which is larger) with connection points that allow disconnection on the branch level while maintaining appropriate voltage levels, and thus lighting levels, across all lights. For example, a lesser electrical distribution would unevenly distribute voltage across the lights, rendering some lights brighter or dimmer than others at different portions of the tree. Additionally, a lesser electrical distribution could have multiple connection points on one branch, reducing the ability to easily remove and replace a broken light string and corresponding branch. As another example, a lesser electrical distribution could have too few connection points (e.g., no connection points on some branches), requiring branches to be replaced when not needed. That is, the branch itself has no electrical issue, but needs to be replaced as it is attached in series with an electrical issue on another branch. Finally, a lesser electrical distribution would result in insufficient or too much power to the lights, rendering the tree inoperable.

As shown, the example artificial tree 1100 has a tiered electrical configuration as follows. The artificial tree can include a first trunk section 1105, a second trunk section 1110, and a third trunk section 1115. Each trunk section can include one or more electrical connectors configured to transmit operating power and/or data signals between trunk sections. As further depicted, each section 1105, 1110, 1115 includes a distribution hub 1135, 1137, and 1139 releasably electrically connected to the trunk power system. Other artificial trees may have any number of sections or distribution hubs. Subsystems and distribution hubs may be connected in series or parallel.

As shown in FIG. 11A, the distribution hub 1135 is releasably electrically connected to a subsystem 1141. The distribution hub 1137 is releasably electrically connected to a plurality of subsystems 1143, four subsystems. The distribution hub 1139 is releasably electrically connected to a plurality of subsystems, three subsystems 1145. While shown having three, four, and one subsystem, a distribution hub may be releasably connected to any suitable number of subsystems. Each subsystem may include any suitable number of wiring harnesses, lighting strings, lights, other suitable components, or a combination thereof. The number of subsystems, distribution hubs, and sections shown by the figures herein is merely illustrative of some examples.

FIG. 11B depicts the artificial tree 1100 and further details the components of subsystems 1141, 1143, and 1145. The distribution hubs 1135, 1137, and 1139 are configured to releasably connect with one or more wiring harnesses 1130 or parallel-series connected light strings 1125. Also shown, the one or more wiring harnesses 1130 are configured to releasably connect with one or more parallel connected light strings 1120.

In the exemplary depicted design, the first, or lower, trunk portion 1105 receives an input power of 18V DC, which it then transmits along the trunk and through the trunk connector to the second, or middle, portion 1110. The middle trunk portion 1110 in turn transmits the same input power along the trunk and through its respective trunk connector to the third, or upper, trunk portion 1115. As a result, the trunk column is electrified with 18V DC power running throughout.

The lower trunk portion 1105 includes a distribution hub 1135 configured to connect with a wiring harness 1130 that includes twelve different light string connection points that are wired such that 6 serially connected light strings are in parallel with 6 other serially connected light strings. As a result, the 18 V input power is split into two parallel pathways each splitting the 18 V across six light string connection points each receiving 3V DC power. The input voltage in other examples may be other suitable voltages (e.g., 30V, 24V, 15V). These connection points (and all connection points of the artificial tree 1100) can be connected to with electrical connectors. As will be appreciated, the working voltage of a parallel wired LED light string is the same as each LED lamp, which may be approximately 2.6-3V, depending on the LED chip. Each light string connection point is then connected to a parallel wired light string 1120. The light strings 1120 are similar to previously discussed light strings 215. Accordingly, the electrical depiction of each light string 1120 represents a previously discussed physical releasably connected pre-lit branch assembly 200. Accordingly, the lower trunk portion 1105 includes twelve releasably connected pre-lit branch assemblies 200.

Moving up the tree, the middle trunk portion 1110 includes a distribution hub 1137 that splits the input power into four different pathways each configured to connect with a respective wiring harness 1130. The top and bottom wiring harness includes six different light string connection points that are wired in series. As a result, the 18 V input power is split across six light string connection points each receiving 3V DC power. Each light string connection point is then connected to a parallel wired light string 1120. The middle two wiring harnesses, which are similar to the wiring harness on the bottom trunk section 1105, include twelve different light string connection points that are series parallel wired. As a result, the 18 V input power is split into two parallel pathways each splitting the 18 V across six light string connection points each receiving 3V DC power. Each light string connection point is then connected to a parallel wired light string 1120. Accordingly, the middle trunk portion 1110 includes thirty-six releasably connected pre-lit branch assemblies 200.

The top trunk portion 1115 includes a distribution hub 1139 that splits the input power into three different pathways. One of the pathways is configured to connect with a wiring harness 1130 and the other two pathways are configured to connect directly to respective parallel-series connected light strings 1125. The parallel-series connected light strings 1125 include six parallel connected light strings wired in series, thus each will receive 3V DC. These light strings 1125 are distributed about the uppermost portion of the top trunk portion 1115, which is sometimes referred to as a tree topper portion of a tree. The wiring harness 1130 includes twelve different light string connection points that are series parallel wired. As a result, the 18 V input power is split into two parallel pathways each splitting the 18 V across six light string connection points each receiving 3V DC power. Each light string connection point is then connected to a parallel wired light string 1120. Accordingly, the top trunk portion 1115 includes twelve releasably connected pre-lit branch assemblies 200.

As depicted, the artificial tree 1100 includes trunk sections having multiple sets of branches. The number of branches per set is based on the wiring diagram and the input voltage. Here, where the input voltage is 18V DC and the lights strings incorporate parallel wired LED lights, the sets of branches must be in factorials of the input power. In order to increase flexibility of the design further, one or more additional voltage channels can be utilized.

For example, two direct current power channels can be utilized and are run into, thru, or along the trunk portions, which can be nominally 17 volts and 23 volts, or other voltages. When working with parallel wired LED light strings, the 17 volts will be split into 6 outputs of less than 3 volts and the 23 volts will be split into 8 outputs of less than 3 volts. By using two different voltages, the trunk sections through the power/data distribution tree can be designed and made with 3, 4, 6 or 8 forked branches for each layer, thereby providing maximum design flexibility. Such design flexibility increases the ease in designing trees differing in appearance as to branches and foliage.

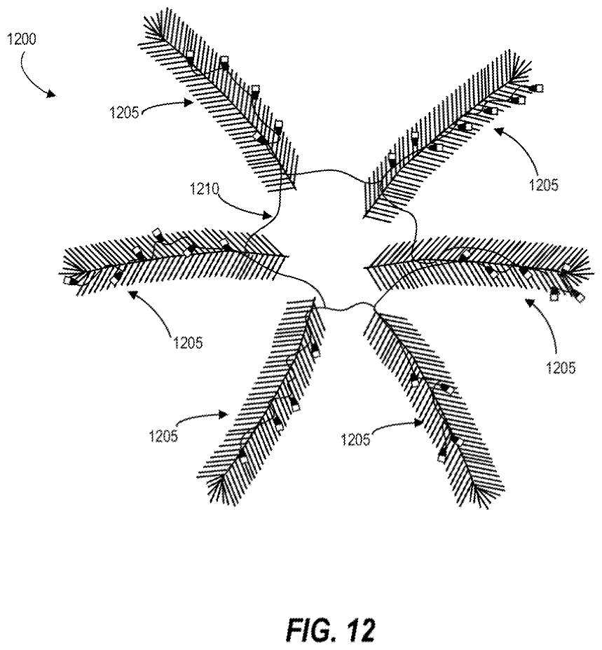

FIG. 12 depicts a releasably connected pre-lit branch assembly 1200 having a plurality of branches1205 electrically connected to one another via a wiring harness 1210, in accordance with some examples of the present disclosure. The releasably connected pre-lit branch assembly 1200 can include a plurality of branches1205, each having their own light strings, that can be electrically connected together via a wiring harness 1210. As depicted, the plurality of branches1205 can be oriented concentrically about the trunk. An artificial tree can have a similar arrangement of branches at various heights about the trunk portion. In the example of the present disclosure incorporating releasably connected pre-lit branch assembly 1200, each group of branches disposed at the same height of the trunk portion can be connected together and the group of branches be releasably connected as opposed to a single branch. As will be appreciated, such a design still provides many of the stated benefits herein, while also decreasing the number of intermediate connectors needed to distribute power and/or data signals through the tree. Though the concentric orientation of branches1205 is depicted, the disclosure is not so limited. The concept of releasably connected could be applied to branches connected together in various geometric positions both relative one another and relative the trunk. For example, in some examples, it could be desirable to have the branches1205 only disposed about a portion of the tree (e.g., not completely encircling).

FIG. 13 depicts a perspective view of the mechanical connection of an releasably connected pre-lit branch assembly 200 on a section 1320 of an artificial tree. As shown, removable fastener assembly 1300 for connecting and detaching the branch assemblies from the tree pole including a clevis 1305, a clevis pin 1310, and a cotter pin 1315.

FIGS. 14A and 14B depict a removable fastener 1405 and end cap 1410 and 1412 in accordance with some aspects of the disclosure. As will be appreciated, the type of mechanical connecting assembly can be varied so long as it is able to be connected and disconnected such that the pre-lit branch assembly 200 can be releasably connected. For example, as depicted, the removable fastener assembly 1300 is configured to releasably fasten a pivotal branch portion to a tree. In other examples, branch portions of a pre-lit branch assembly 200 can be configured to affix to the trunk portion in a fixed, or nonpivoting manner. The cap 1410 has a rounded, radially outward extending cavity. The cap 1412 has a jagged, radially outward extending cavity. In such an example, the removable fastener assembly 1300 can include other fastening mechanisms, such as, but not limited to, pluggable fastening, screw type fastening, etc.

Further, aspects of the present disclosure relate to improved methods of manufacturing artificial trees that include releasably connected component assemblies, such as those described throughout the previous description. As previously stated, the linearity of the present methods of manufacturing trees introduce inefficiencies as the timing and location of the manufacturing process is heavily tied the locations where skilled workers exist. Such geographic restriction can result in the final assembled trees being very far away from many consumers, thus requiring heavy and bulky trees to be shipped around the globe, at great cost and added fuel usage. To overcome these geographic restrictions, the present disclosure provides for improved methods of distributed manufacturing and assembling of artificial trees.

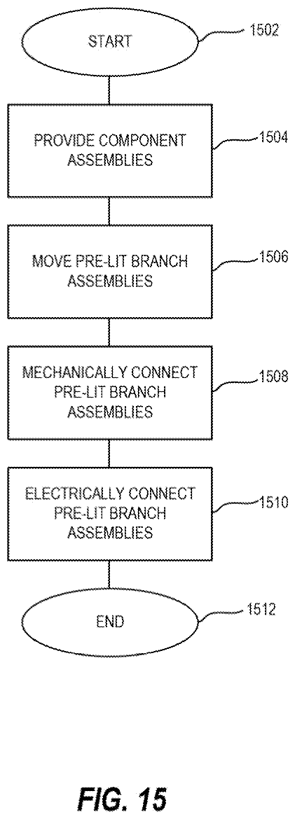

FIG. 15 depicts a method of assembling an artificial tree in accordance with some examples of the present disclosure. The method may include starting at step 1502.

At step 1504, the method may include providing a plurality of component assemblies, such as those described herein. For example, at step 1504, the method may include providing a plurality of releasably connected pre-lit branch assemblies (or other component assemblies such as a wiring harness, distribution hub, trunk, or a combination thereof). At step 1504, the method may include installing a plurality of lights on a plurality of releasably connected branch assemblies to form a plurality of pre-lit releasably connected branch assemblies. At step 1504, the method can include wiring a plurality branch assemblies with a plurality of light strings to form a plurality of releasably connected pre-lit branch assemblies. The wiring may include twisting, wrapping, or fastening the plurality of light strings to the plurality of branch assemblies or a combination thereof.

At step 1506, the method may include moving the plurality of releasably connected pre-lit branch assemblies to another facility. Step 1506 may facilitate components of the tree to be shipped or otherwise moved before assembly is complete thus saving on manufacturing and shipping costs. It also may facilitate the ability to provide skilled labor before shipping or moving, resulting in additional savings.

At step 1508, the method may include releasably mechanically connecting the plurality of releasably connected pre-lit branch assemblies. The releasably connected pre-lit branch assemblies may be releasably mechanically connected to a wiring harness, a distribution hub, a trunk, a trunk section, or a combination thereof. For example, Step 1508 can include mechanically connecting a plurality of releasably connected pre-lit branch assemblies to the trunk via an attachment mechanism Step 1508 may include releasably mechanically connecting the releasably connected pre-lit branch assemblies though use of clevis pins, devises, clutter pins, magnets, protrusions, receptacles, removable fasteners, cap cavities, interlocking mechanisms, any other suitable releasable mechanical connecting components, or a combination thereof.

At step 1510, the method may include releasably electrically connecting the plurality of releasably connected pre-lit branch assemblies. The plurality of releasably connected pre-lit branch assemblies may be releasably connected to a wiring harness, a distribution hub, a trunk, a trunk section, or a combination thereof. Step 1510 may include mating one or more electrical connectors (e.g., plugs, pins, receptacles, other suitable connectors, or a combination thereof) of the plurality of releasably connected pre-lit branch assemblies to one or more electrical connectors (e.g., plugs, pins, receptacles, other suitable connectors, or a combination thereof) of a wiring harness, a distribution hub, a trunk, a trunk section, or a combination thereof. Additionally or alternatively, Step 1508 may include mating one or more electrical connectors of a wiring harness to a distribution hub, trunk, or both. The method may include ending at step 1512.

As will be appreciated such methods provide substantial savings in fuel and other shipping costs by reducing the geographic restrictions thus enabling producers to make the optimum use of skilled labor as part of a diversified supply chain. For example, utilizing such a distributed manufacturing process allows craftsmen in one location can contribute the component or parts of the tree necessitating their skill, while lesser skilled laborers in other locations can contribute to the production of other parts or components and in turn substantially manufacture of the full and final product in locations closer to consumers.

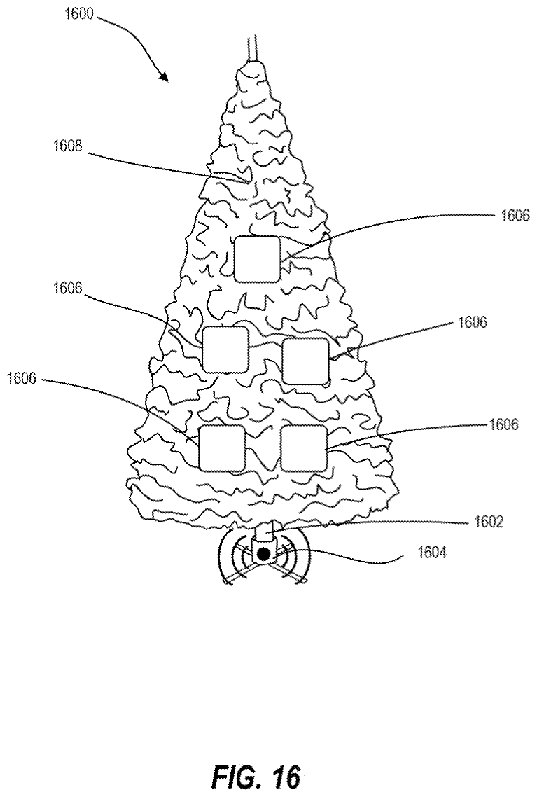

In some examples of the present disclosure, a transmitter can be connected to the pole or base of a tree, or separately situated in or around the tree, and can utilize electromagnetic radiation. Use of wireless transmission reduces the connections needed to transmit electrical signals (such as power or data) throughout the tree. This beam can take the form an electrical signal operable to power or transmit data to lights. The transmission can be visible light, microwave radiation, near infrared radiation or any appropriate frequency or frequencies, depending on the technology chosen. For example, wireless transmission of energy can be used to provide power for the lights on the branches without having to use connectors between wiring in or along the pole or tree trunk and the branches. This can be accomplished by near field or non-radiative wireless transmission which enables power to be transferred over short distances by magnetic fields using inductive connecting between coils of wire, or by electric fields using capacitive connecting between metal electrodes. FIG. 16 depicts an artificial tree 1600 in accordance with some examples of the present disclosure for wireless transmission. A trunk 1602 includes a wireless transmitter 1604. The wireless transmitter 1604 is operable to transmit power or data signals to a plurality of receivers 1606. The receivers 1606 can be part of the plurality of releasably connected pre-lit branch assemblies 1608, power distribution hubs, trunk sections, other portions of the tree 1600, or a combination thereof. Similar to the focusing of the transmitted power, it is possible for the plurality of receivers 1606 to concentrate the received power for conversion, using receiving arrays, antennas, reflectors or similar means. Additionally or alternatively, a power distribution hub 1610 may include a wireless transmitter, receiver, transceiver, or a combination thereof. As will be appreciated, any one or more of the trunk 1602, the pre-lit branch assemblies 1608, may include transmitters, receivers, or transceivers, to transmit or receive signals controlling or powering the brightness or effect of the lights 1612.

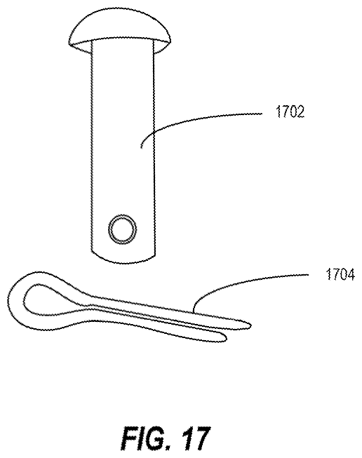

FIG. 17 depicts an example cotter pin and clevis pin in accordance with some aspects of the disclosure. For example, a clevis pin 1702 and cotter pin 1704 may be used to releasably connect a pre-lit branch assembly to a tree. The clevis pin 1702 may fit the cotter pin 1704 to connect a pre-lit branch assembly to a tree or a clevis, as shown for example by FIG. 13. The clevis pin 1702 and cotter pin 1704 provide an example of connecting hardware but any suitable variety of connecting hardware may be used.

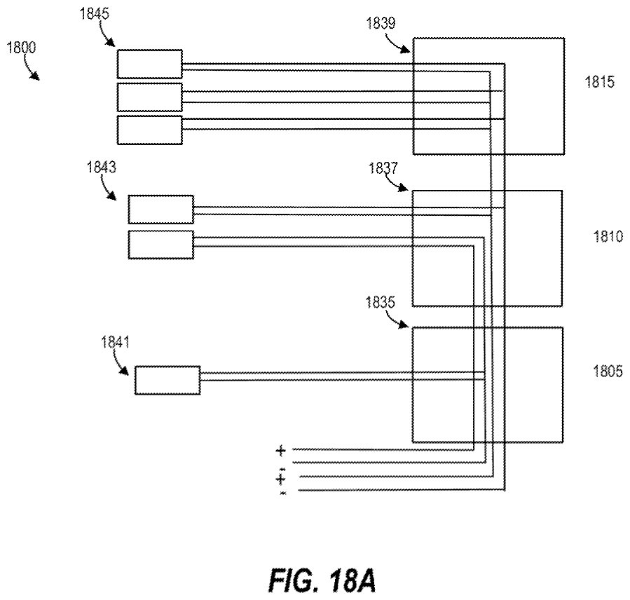

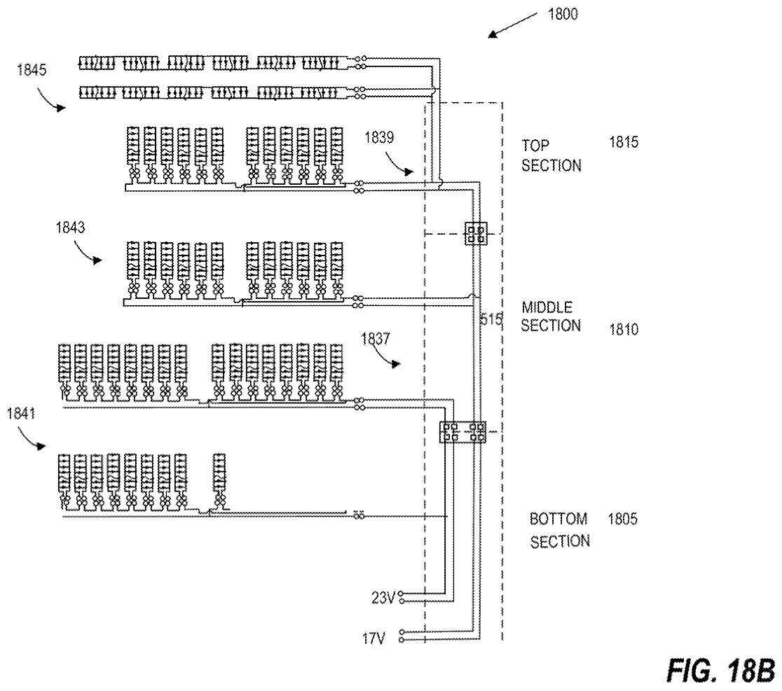

FIGS. 18A and 18B depict an electrical wiring diagram of an assembled artificial tree 1800 with releasably connected pre-lit branch assemblies, in accordance with some examples of the present disclosure. The artificial tree 1800 has a dual-voltage tiered electrical configuration facilitating releasably connecting in an artificial tree by maintaining acceptable voltage levels for lights, while simultaneously distributing lights among connection points as would be physically practical and aesthetically pleasing. That is, the depicted tiered electrical configuration of the artificial tree 1800 has an appropriate number of lights at the top of a tree (which is smaller) and a larger amount of lights at a base of a tree (which is larger) with connection points that allow disconnection on the branch level—while maintaining appropriate voltage levels, and thus lighting levels, across all lights. For example, a lesser electrical distribution would unevenly distribute voltage across the lights, rendering some lights brighter or dimmer than others at different portions of the tree.

The dual input voltage system shown (for example 23V and 17V in FIG. 18B) evenly distributes voltage across tree sections. The dual voltage design gives added flexibility to design a tree, in which a branch count of 3, 4, 6, 8 can be adopted in different layers of a tree. A different branch count may be desirable due to the shape of the tree (e.g., lower sections of the tree are wider and have additional branches).

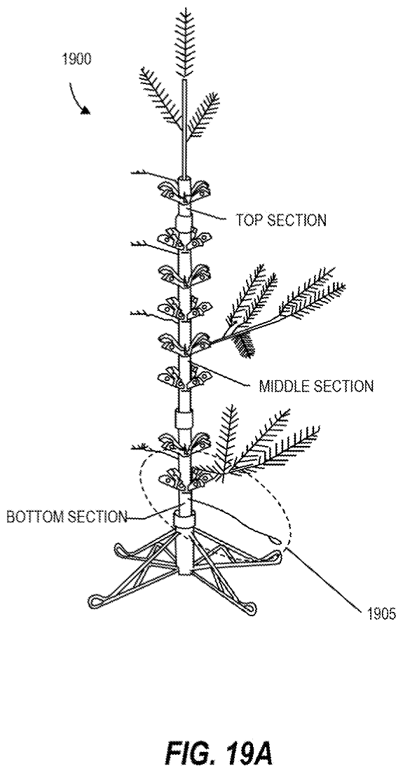

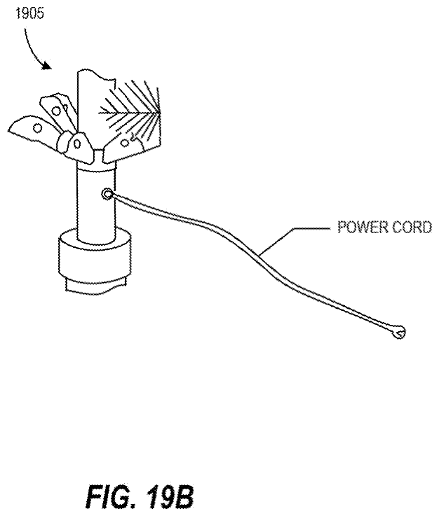

FIGS. 19A and 19B depict an assembled artificial tree 1900 with releasably connected pre-lit branch assemblies in accordance with some examples of the present disclosure. The trunk portion 1905 may include a cord to connect to an outlet or power adapter to receive power.

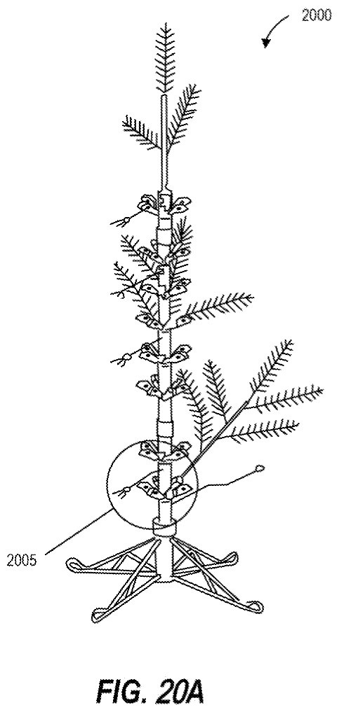

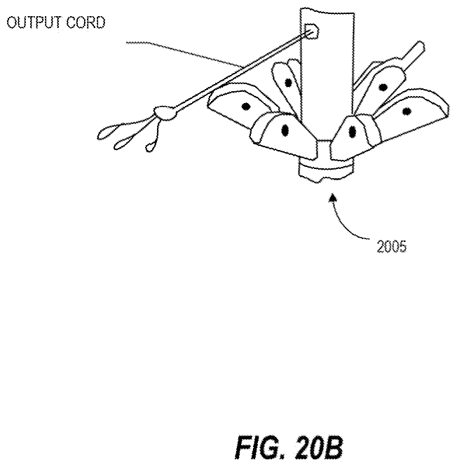

FIGS. 20A and 20B depict an assembled artificial tree 2000 with releasably connected pre-lit branch assemblies in accordance with some examples of the present disclosure. The trunk portion 2005 may include an output cord to releasably electrically connect to branch assemblies, harnesses, or other trunk portions. The trunk portion 2005 also includes a mechanical connector (as shown by the example in FIG. 13) operable to releasably mechanically connect to branch assemblies, harnesses, light strings, lights, or other trunk portions.

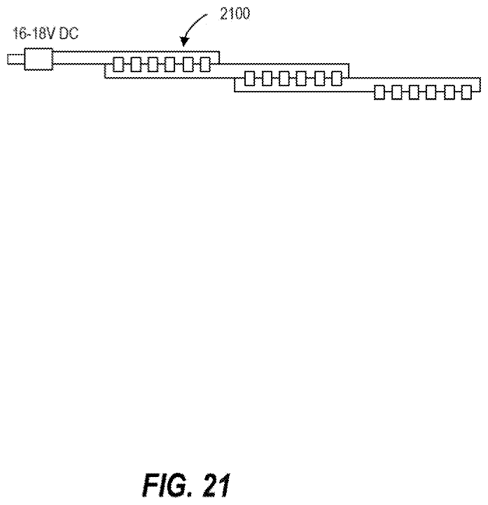

FIG. 21 depicts an example harness 2100 operable to releasably connect to branch assemblies, light strings, lights, other harnesses, or trunk portions. Harness 2100 depicts an example of an electrical connection distribution, operable to connect to numerous components.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

What is claimed is:

1. An artificial tree comprising:
a trunk comprising a trunk power source;
a plurality of electrical connectors; and
a plurality of releasably connected pre-lit branch assemblies, the pre-lit branch assemblies comprising a plurality of lights, the plurality of branch assemblies operable to releasably mechanically connect to the trunk and releasably electrically connect to the plurality of electrical connectors.

2. The artificial tree of claim 1, wherein:
the trunk comprises a plurality of wiring harnesses;
the plurality of wiring harnesses comprises the plurality of electrical connectors; and
the plurality of releasably connected pre-lit branch assemblies comprises a plurality of branch segments operable to releasably electrically connect to the plurality of wiring harnesses when releasably electrically connected to the plurality of electrical connectors such that each of the plurality of branch segments may receive power from the trunk.

3. The artificial tree of claim 2, wherein at least some of the plurality of branch segments are oriented concentrically around the trunk when releasably electrically connected to a wiring harness of the plurality of wiring harnesses.

4. The artificial tree of claim 1, further comprising a removable fastener assembly operable to releasably connect a pivotal branch portion of at least one of the releasably connected pre-lit branch assemblies to the artificial tree.

5. The artificial tree of claim 4, wherein the removable fastener assembly comprises a fastener and a cap, the cap comprising a radially outward extending cavity.

6. The artificial tree of claim 4, wherein the removable fastener assembly comprises a clevis, a clevis pin, and a cotter pin.

7. The artificial tree of claim 1, wherein the trunk comprises a plurality of trunk sections, each trunk section comprising a distribution hub and a trunk section connector for electrically connecting to at least one other trunk section of the plurality of trunk sections, the power distribution hub operable to electrically connect to a plurality of wiring harnesses or a plurality of light strings.

8. The artificial tree of claim 1, further comprising a dual input voltage system, wherein the trunk is operable to provide power at a first voltage and a second voltage such that at least one of the plurality of releasably connected pre-lit branch assemblies is operable to receive power from the trunk at the first voltage while at least another of the plurality of releasably connected pre-lit branch assemblies is operable to receive power from the trunk at the second voltage.

9. The artificial tree of claim 8, wherein the trunk comprises a lower trunk section, a middle trunk section, and a top trunk section, each of the trunk sections comprising a distribution hub, wherein the distribution hub of the lower trunk section powers a greater number of the plurality of lights when the plurality of releasably connected pre-lit branch assemblies are releasably electrically connected to the plurality of electrical connectors.

10. The artificial tree of claim 8, wherein the trunk comprises a plurality of trunk sections, each trunk section comprising a distribution hub, wherein at least one of the distribution hubs provides power at the first voltage and the second voltage.

11. The artificial tree of claim 8, wherein the first voltage is 17 Volts and the second voltage is 23 Volts.

12. The artificial tree of claim 1, wherein the trunk comprises a wireless power source and the plurality of electrical connectors are configured to wirelessly receive power from the wireless power source and distribute the power to the plurality of lights.

13. The artificial tree of claim 1, wherein the trunk comprises a distribution hub operable to send a control signal to adjust the brightness, color, flicker, or flash of at least some of the plurality of lights.

14. The artificial tree of claim 1, wherein each of the plurality of pre-lit branch assemblies each comprise:
a plurality of branches; and
a light string disposed on the branches, each light string comprising a light string electrical connector configured to mate with one of the plurality of electrical connectors.

15. The artificial tree of claim 14, wherein the plurality of electrical connectors are built into the trunk.

16. A method of manufacturing an artificial tree, the method comprising:
installing a plurality of branch assemblies with a plurality of light strings to form a plurality of releasably connected pre-lit branch assemblies;
releasably mechanically connecting the plurality of pre-lit branch assemblies to a trunk; and
releasably electrically connecting the plurality of pre-lit branch assemblies to a plurality of electrical connectors.

17. The method of claim 16, wherein the step of installing a plurality of branch assemblies with a plurality of light strings further comprises fastening the plurality of light strings to the plurality of branch assemblies.

18. The method of claim 16, further comprising moving the plurality of releasably connected pre-lit branch assemblies to another facility.

19. The method of claim 16, wherein the step of releasably electrically connecting the plurality of pre-lit branch assemblies to a plurality of electrical connectors comprises electrically connecting the plurality of pre-lit branch assemblies to a plurality of wiring harnesses.

20. The method of claim 16, wherein the step of releasably electrically connecting the plurality of pre-lit branch assemblies to a plurality of electrical connectors comprises electrically connecting a plurality of wiring harnesses to a distribution hub.
